(19) United States
(12) Patent Application Publication
(10) Pub. No.: US 2006/0091724 A1
(43) Pub. Date: May 4, 2006

(54) Method for operating a hydraulic vehicle-braking system

(76) Inventors: Erhard Beck, Weilburg (DE); Jurgen Woywod, Morfelden (DE); Ralph Gronau, Wetter (DE); Dieter Burkhard, Bingen-Budelheim (DE)

Correspondence Address: RATNERPRESTIA, P O BOX 980, VALLEY FORGE, PA, 19482-0980, US

(21) Appl. No.: 10/534,532

(22) PCT Filed: Nov. 13, 2003
(86) PCT No.: PCT/EP03/50827

§ 371 Date: May 11, 2005

(30) Foreign Application Priority Data
Nov. 16, 2002 (DE) 102 535 30.2

(51) Int. Cl. B60T 8/44

(52) U.S. Cl. 303/114.1

(57) ABSTRACT

In a method for operating a hydraulic vehicle brake system, it is arranged for that hydraulic pressure is metered directly into a master brake cylinder by way of a preceding hydraulic booster, and in which the hydraulic pressure is controlled in accordance with a quantity representative of the driver's braking request because the pressure in the preceding hydraulic booster is controlled by actuation of at least two analog or analogized valves. The invention relates

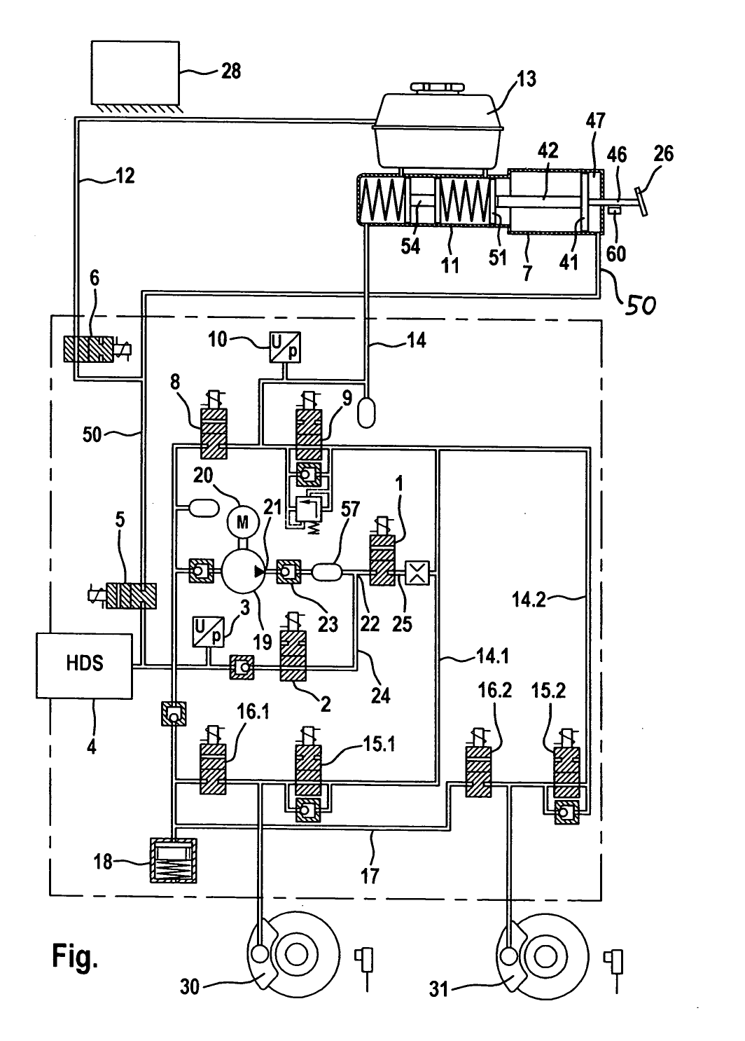

### TECHNICAL FIELD

The present invention relates to a method for operating a hydraulic vehicle brake system, in which hydraulic pressure is introduced by means of a hydraulic booster.

### BACKGROUND OF THE INVENTION

Vacuum supply for brake force assistance purposes has become more rare in new engine technology such as Diesel engines or gasoline direct injection engines. This fact necessitates brake systems with active hydraulic brake force assistance or with an additional vacuum pump for the operation of a vacuum brake booster.

Systems with a vacuum brake booster (booster) and additional active hydraulic brake force assistance which additionally support the driver in the application of the brake pedal by means of an actuatable hydraulic pump, e.g. the ABS return pump, are known in the art. These systems raise the point of maximum boosting of a vacuum brake booster without replacing it. However, they may cause shortcomings in terms of comfort. A pedal feel can be encountered in some situations, which differs from ‘accustomed’ vacuum brake booster assistance in a negative way.

Further, methods are known in which braking pressure is generated by the electronic actuation of an independent pressure source, with the brake pedal being uncoupled from the hydraulic brake system in the normal case of braking (brake-by-wire systems). These systems require a high extent of technical effort and structure to achieve that sufficient braking effect can be ensured even in the case of a fault.

### BRIEF SUMMARY OF THE INVENTION

An object of the invention is to provide a control of a hydraulic booster with low technical effort allowing reliable and comfortable hydraulic brake force assistance.

According to the invention, this object is achieved by the features of the independent patent claims. Preferred embodiments are indicated in the sub claims.

Accordingly, the above object is achieved in that the hydraulic pressure is metered directly into a master brake cylinder by way of a preceding hydraulic booster, and in that the hydraulic pressure is controlled in accordance with a quantity representative of the driver's braking request because the pressure in the preceding hydraulic booster is controlled by actuation of at least two analog or analogized valves.

An analog or analogized valve can adopt all positions between ‘open’ and ‘closed’ by means of an electrical or electronic independent actuation, respectively, so that the braking pressure for controlled or comfortable braking operations can be increased or reduced invariably. It is preferred that the analog or analogized valve is adjusted with a current value.

Preferably, the master brake cylinder is of dual-circuit design and configured as a tandem master cylinder (TMC) in particular.

It is provided according to the invention that the hydraulic pressure in the preceding hydraulic booster is controlled by actuation of a first analog or analogized valve, which controls the conduction of pressure fluid from the hydraulic booster into a pressure fluid supply tank, and by actuation of a second analog or analogized valve, which controls the supply of the pressure fluid from an independent pressure source into the hydraulic booster.

The pressure fluid supply tank is favorably unpressurized.

According to the invention, it is provided that the pressure of the independent pressure source is generated by actuation of a motor of a motor-pump unit and stored in a hydraulic high-pressure accumulator.

Preferably, there is use of a hydraulic return pump or, respectively, a motor-pump unit for return delivery already provided in a brake system.

According to the invention, it is provided that the analog or analogized valves are actuated for the purpose of application of a defined hydraulic pressure to a booster piston of the hydraulic booster, said pressure being introduced into the wheel brakes of the vehicle by way of a master brake cylinder piston operatively connected to the booster piston in the force output direction.

It is provided according to the invention that the braking pressure is controlled and/or hydraulic pressure is built up in the high-pressure accumulator by actuation of electronically controllable valves.

It is arranged for by the invention that the driver can introduce hydraulic pressure into the brake system by way of a direct operative connection between the preceding hydraulic booster and a brake pedal.

This enables the system to safeguard an emergency braking function in the event of failure.

According to the invention, it is provided that the pedal travel of a brake pedal and/or a quantity derived from the pedal travel, in particular pedal speed or pedal acceleration, is used for detecting the driver's braking request. This means that the pedal travel of the brake pedal and/or a quantity derived therefrom is used as a quantity representative of the driver's braking request.

It is provided according to the invention that the pressure in the preceding hydraulic booster is determined or estimated on the basis of a measured hydraulic pressure in the master brake cylinder.

According to the invention, it is provided that the pressure in the hydraulic high-pressure accumulator is monitored by means of a pressure sensor.

It is provided according to the invention that only one hydraulic valve is operated for charging the hydraulic high-pressure accumulator.

It is provided according to the invention that the charging operation of the hydraulic pressure accumulator starts before a bottom switch point of a pressure sensor at the high-pressure accumulator is reached.

According to the invention, it is provided that the charging operation of the hydraulic high-pressure accumulator takes place in periods of rising and/or constant load of the driving engine of the vehicle.

It is provided according to the invention that the charging operation of the hydraulic high-pressure accumulator is discontinued upon brake application and/or in the event of a load of the driving engine of the vehicle.

It is provided according to the invention that the charging operation of the hydraulic high-pressure accumulator (4) takes place when the load of the driving engine of the vehicle is equal to zero (0) or lower than zero (<0), i.e. when the driving engine is stalling, and/or when a generally constant speed of the vehicle prevails.

It is provided according to the invention that the pressure is additionally increased by way of a pressure-increasing unit, preferably a hydraulic pump, when the point of maximum boosting of the hydraulic booster is exceeded.

It is further arranged for determined applications that the booster is rated only to achieve a relatively low booster output, and that in this case the pressure is additionally increased by means of a pressure-increasing unit, preferably a hydraulic pump.

It is provided according to the invention that a quantity representative of the driver's braking request is used as a command variable for the additional pressure increase.

Preferably, the pedal travel of a brake pedal and/or a quantity derived from the pedal travel, in particular pedal speed or pedal acceleration, is used as a quantity representative of the driver's braking request.

According to the invention, it is provided that a point of maximum boosting of the hydraulic booster is determined on the basis of a ratio between the pressure in the hydraulic accumulator and the pressure in the master brake cylinder and a constructive ratio between the surface of a hydraulic piston in the hydraulic booster and the surface of a hydraulic piston in the master brake cylinder.

It is provided according to the invention that the braking pressure in the wheel brakes is controlled by way of switching two electronically actuatable valves in a hydraulic system that is closed in particular.

### BRIEF DESCRIPTION OF THE DRAWINGS

The FIGURE shows a brake system according to the invention.

### DETAILED DESCRIPTION OF THE PREFERRED EMBODIMENTS

The braking pressure generator includes a hydraulic booster (7) being designed as an extension of the actuating unit (TMC-tandem master cylinder) 11 with tank 13. Booster piston 41 is guided in a booster housing, and a push rod 42 of booster piston 41 is supported in piston 51 of the push-rod circuit of the TMC 11 or guided by way of a corresponding disc-like increase of the diameter in the TMC bore (not shown). Behind the booster piston 41 being in its rest position, a control line 50 opens into a chamber 47 disposed behind the booster piston 41. A push rod 56 of the brake pedal 26 enters the booster 7, whereby an emergency actuation of the TMC 11 is enabled should the booster 7 fail. This emergency actuation corresponds to the emergency actuation of a vacuum brake booster.

The ratio between the surface of booster piston 41 and the TMC surface, in connection with the pressure supplied by a high-pressure source, results in the TMC pressure that can be reached by boosting. To reach the maximally demanded pressure, it is arranged for to realize a corresponding constructive design of the ratio of surfaces and/or rate the high-pressure accumulator for a corresponding pressure to be maximally stored.

Preferably, a hydraulic high-pressure accumulator is used as a high-pressure source, being fed by a hydraulic pump with pressurized fluid, i.e. being ‘charged’. A return pump already provided in the system is favorably used to charge an accumulator.

The accumulator is charged after a braking operation for example when a hydraulic pressure lower than 40 to 50 bar is reached in the accumulator, what corresponds to a braking pressure (maximum boosting pressure) of 80 to 90 bar. The pump requires a charging time of roughly 2 to 3.5 sec until an upper limit value for the hydraulic pressure in the accumulator of 50 to 70 bar is reached, corresponding to a maximum boosting pressure of 100 to 110 bar. If the hydraulic accumulator is emptied completely due to repeated braking operations, e.g. a number of about 15 braking operations, the pump will require roughly 30 to 40 sec to replenish the hydraulic accumulator up to a hydraulic pressure of 50 to 70 bar. This rating ensures an appropriate supply of the hydraulic brake booster and, thus, support of the driver's pedal force by means of auxiliary energy.

Further, the FIGURE shows a brake circuit (of two brake circuits in total) connected to the actuating unit 11 and acting upon two wheel brakes 30, 31. The second brake circuit for the other two wheel brakes is identical to the brake circuit shown in design and function and, therefore, need not be described in detail.

The brake circuits are acted upon by the master cylinder (TMC) 11, which is fed with hydraulic fluid (pressure fluid) out of hydraulic supplies of a tank 13. The master cylinder 11 is actuated by way of the hydraulic brake booster 7 described hereinabove. The pressure demanded by the respective control or regulation of an electronic unit 28 is generated by way of the hydraulic booster 7 and the master cylinder 11.

However, in the case of a malfunction or failure of the hydraulic pressure applied to the piston 41, it is possible for the driver to actuate said piston also directly, i.e. in a mechanical manner, by means of an actuating element (push rod 46). Thus, the system safeguards a fail-safe function by means of a direct hydraulic/mechanical through grip.

By way of normally open (NO) valves 15.1 and 15.2, the wheel brakes 30, 31 are supplied with pressure directly from the tandem master cylinder 11 through a line 14, a NO separating valve 9 and subsequent lines 14.1 and 14.2, and the TMC 11 is actuated by way of the hydraulic booster 7, to which hydraulic pressure out of a pressure source 4, 19, 20 can be applied.

The braking pressure is discharged by way of a return line 17 and normally closed (NC) valves 16.1 and 16.2, a low-pressure accumulator 18 and the pump.

High-pressure accumulator 4 is normally charged by means of the normally open valve 2. When the pressure in the high-pressure accumulator falls below a predetermined nominal value, in particular below 50 bar to 70 bar, brake fluid is aspirated from the TMC 11 by way of the open change-over valve 8 and by means of the pump 19 operated by motor 20. The brake fluid is pumped into the high-pressure accumulator 4 through a non-return valve 23 linking to the pressure side 21 of the pump 19, a damping chamber 57, a line branching 22, and a line 24 into which the valve 2 and a pressure sensor 3 are inserted. As this occurs, motor 20 is actuated until a predetermined nominal pressure is reached. The pressure is measured by a pressure pick-up (pressure sensor 3). When the high-pressure accumulator 4 is filled (accumulator charging) the valve 5 arranged in a line 50 between high-pressure accumulator 4 and booster 7 is closed. The pressure side of the pump is connected to the wheel brakes 30, 31 also by way of branching 22 and a subsequent line 25 into which a valve 1 is inserted. Preferably, valve 1 is normally closed (NC valve), while valve 2 is normally open (NO valve). These valves are not energized during charging of the accumulator, and favorably only the change-over valve 8 must be energized for filling in this case.

A control in a closed hydraulic system is possible due to switching the valves 1 and 2 during a normal braking pressure control such as in the case of an ABS or ESP control. This ensures the separation of media, what is advantageous with respect to any possible gas evolution in the high-pressure accumulator. The charging pressure of the high-pressure accumulator is rated in dependence on the layout, on the booster and the tandem master cylinder pressure aimed at.

It is likewise possible to design the valve 1 as a NO valve and the valve 2 as a NC valve, it being required then to reverse the switch conditions accordingly.

At high control frequencies and a low volume requirement in the wheel brake, the whole or part of the volume discharged can be used for charging the high-pressure accumulator 4.

The charging operation is carried out preferably in periods where the engine load of the driving engine or a quantity representative of the engine load such as the throttle valve position and/or accelerator pedal position is roughly constant or prevails with a rising gradient. A significantly declining gradient of the engine load will interrupt the charging operation. A charging operation will not take place, or current charging operations are stopped in periods with no engine load (engine load=0) and/or brake application. In periods where engine stall torque prevails (engine load<0) and/or a constant vehicle speed is detected, charging operations of the high-pressure accumulator are admitted when no other control functions such as brake intervention of a superior control system like automatic cruise control (ACC system) are engaged.

When braking by the driver is detected, the charging operation of the high-pressure accumulator 4 will be stopped immediately.

Braking detection is executed by way of a pedal travel sensor 60 or by means of any other sensor detecting the braking request of the driver.

When a braking request is detected by the sensor means 60, the valve 5 of preferably analog operation is correspondingly opened in dependence on the displacement travel of the push rod 46 of the brake pedal 24 and/or the actuating speed so that brake fluid can flow from the charged high-pressure accumulator 4 into the chamber 47 arranged behind the booster piston. A pressure sensor 10 monitors pressure development in the booster 7 by way of the pressure that builds up in the TMC. That means a defined travel is associated with a defined pressure in the TMC and controlled. In this arrangement, the booster piston 41 moves in front of the push rod 46 of the brake pedal 26 that advances into the booster chamber at an increasing rate, without any contact developing or having to develop. It is favorable to arrange elastic means, in particular a spring, between the push rod 46 and the booster piston 41 in order to achieve an elastical coupling.

When the driver releases the brake pedal, meaning the travel decreases again, the valve 5 will be closed, and a valve 6 that is likewise of preferably analog operation and disposed between the high-pressure accumulator 4 and the tank 13 will be opened by analog control corresponding to the withdrawal of the driver's request, and brake fluid can flow back into the supply tank 13 again. The favorable design of the valve 6 as NO valve renders it possible to actuate the booster in the event of system failure without vacuum developing in the booster 4 (or in the booster chamber 47, respectively) because volume compensation takes place by way of valve 6. With this braking detection the driver is only required to overcome the additional force, which is generated by the pressure already prevailing in the booster 7. This additional force depends only on the surface of the push rod 45 projecting into the booster 7.

The method of the invention and the combination of the hydraulic booster and the auxiliary pressure source with high-pressure accumulator 4 can be designed so that the booster produces the total braking pressure required. However, this fact will increase the necessary accumulator pressure in the high-pressure accumulator 4.

In another embodiment, only a reduced maximum braking pressure of the booster (maximum boosting pressure) is at disposal (similar to a vacuum brake booster). Said braking pressure will then cover already a large range of all braking operations, e.g. all ‘normal braking operations’ in the range of a resulting braking pressure of a maximum of 60 to 80 bar. The braking operations in a range requiring a braking pressure (roughly 60 to 80 bar) exceeding this point of maximum boosting are realized by way of an additional pressure buildup by means of the hydraulic pump 19. This can necessitate that the tandem master cylinder piston is ‘pulled away’. In this case, pressure fluid is conducted into the booster chamber 47 by way of line 50 and valve 5, whereby the piston 41 is led to follow. This embodiment is preferred because the mounting space is further reduced thereby. Another advantage can be seen in that in this case only relatively small volumes of brake fluid must be moved, with the result that the dynamics of the system is enhanced. This fact will also reduce the charging times of the high-pressure accumulator 4. Due to the additional hydraulic assistance by means of pump 19, it is also possible to rate the volume of the high-pressure accumulator 4 in such a manner that a reduced frequency of repeated braking operations is complied with. This means that the number of possible braking operations can be reduced to e.g. 2 times 60 bar to 90 bar, preferably roughly 80 bar, of TMC pressure without charging the high-pressure accumulator in the meantime. In the rare cases of an exceeding pressure demand, a corresponding braking pressure can be produced by means of pump 19.

In the embodiment described hereinabove, it is no longer the TMC that is used as the command variable for the additional boosting, but preferably the pedal travel and/or its derivative, for the purpose of detecting the driver's request. To determine the point of maximum boosting or that it is reached, it is arranged for that the point of maximum boosting is found out by way of the ratio between accumulator pressure and TMC pressure and the ratio between booster piston surface and TMC piston surface.

Favorably, the described method is apt for use in electronic brake control systems such as ABS (anti-lock system), EDS (Electronic Differential Lock, traction slip control), ESP (Electronic Stability Program), or HDC (Hill Descent Control). In addition, a use for systems with cruise control (ACC, Adaptive Cruise Control) is also possible, because an automatic pressure compensation of the circuit is carried out by the TMC.

1.-20. (canceled)

21. A method for operating a hydraulic vehicle brake system, in which hydraulic pressure is introduced by means of a hydraulic booster,
wherein the hydraulic pressure is metered directly into a master brake cylinder by way of a preceding hydraulic booster, and wherein the hydraulic pressure is controlled in accordance with a quantity representative of the driver's braking request because the pressure in the preceding hydraulic booster is controlled by actuation of at least two analog or analogized valves.

22. The method as claimed in claim 21,
wherein the hydraulic pressure in the preceding hydraulic booster is controlled by actuation of a first analog or analogized valve, which controls the conduction of pressure fluid from the hydraulic booster into a pressure fluid supply tank, and by actuation of a second analog or analogized valve, which controls the supply of the pressure fluid from an independent pressure source into the hydraulic booster.

23. The method as claimed in claim 21,
wherein the pressure of the independent pressure source is generated by actuation of a motor of a motor-pump unit and is stored in a hydraulic high-pressure accumulator.

24. The method as claimed in claim 21,
wherein the analog or analogized valves are actuated for the purpose of application of a defined hydraulic pressure to a booster piston of the hydraulic booster, said pressure being introduced into the wheel brakes of the vehicle by way of a master brake cylinder piston operatively connected to the booster piston in the force output direction.

25. The method as claimed in claim 21,
wherein the braking pressure is controlled or hydraulic pressure is built up in the high-pressure accumulator by actuation of electronically controllable valves.

26. The method as claimed in claim 21,
wherein the driver can introduce hydraulic pressure into the brake system by way of a direct operative connection between the preceding hydraulic booster and a brake pedal.

27. The method as claimed in claim 21,
wherein the pedal travel of a brake pedal or a quantity derived from the pedal travel is used for detecting the driver's braking request.

28. The method as claimed in claim 21,
wherein the pressure in the preceding hydraulic booster is determined or estimated on the basis of a measured hydraulic pressure in the master brake cylinder.

29. The method as claimed in claim 21,
the method further comprising that the pressure of the independent pressure source is generated by actuation of a motor of a motor-pump unit and is stored in a hydraulic high-pressure accumulator,
wherein the pressure in the hydraulic high-pressure accumulator is monitored by means of a pressure sensor.

30. The method as claimed in claim 21,
the method further comprising that the pressure of the independent pressure source is generated by actuation of a motor of a motor-pump unit and is stored in a hydraulic high-pressure accumulator,
wherein only valve is operated for charging the hydraulic high-pressure accumulator.

31. The method as claimed in claim 21,
the method further comprising that the pressure of the independent pressure source is generated by actuation of a motor of a motor-pump unit and is stored in a hydraulic high-pressure accumulator,
wherein the charging operation of the hydraulic pressure accumulator starts before a bottom switch point of a pressure sensor at the high-pressure accumulator is reached.

32. The method as claimed in claim 21,
the method further comprising that the pressure of the independent pressure source is generated by actuation of a motor of a motor-pump unit and is stored in a hydraulic high-pressure accumulator,
wherein the charging operation of the hydraulic high-pressure accumulator takes place in periods of rising or constant engine load of the driving engine of the vehicle.

33. The method as claimed in claim 21,
the method further comprising that the pressure of the independent pressure source is generated by actuation of a motor of a motor-pump unit and is stored in a hydraulic high-pressure accumulator,
wherein the charging operation of the hydraulic high-pressure accumulator is discontinued upon brake application or in the event of an engine load of the driving engine of the vehicle.

34. The method as claimed in claim 21,
the method further comprising that the pressure of the independent pressure source is generated by actuation of a motor of a motor-pump unit and is stored in a hydraulic high-pressure accumulator,
wherein the charging operation of the hydraulic high-pressure accumulator takes place when the engine load of the driving engine of the vehicle is equal to zero or lower than zero (stalling), and/or when a generally constant speed of the vehicle prevails.

35. The method as claimed in claim 21,
wherein the pressure is additionally increased by way of a pressure-increasing unit, when the point of maximum boosting of the hydraulic booster is exceeded.

36. The method as claimed in claim 21,
wherein the booster is rated to achieve a relatively low booster output, and wherein the pressure is increased additionally by means of a pressure-increasing unit.

37. The method as claimed in claim 35,
wherein a quantity representative of the driver's braking request is used as a command variable for the additional pressure increase.

38. The method as claimed in claim 36,
wherein a quantity representative of the driver's braking request is used as a command variable for the additional pressure increase.

39. The method as claimed in claim 36,
wherein the pedal travel of a brake pedal or a quantity derived from the pedal travel, in particular pedal speed or pedal acceleration, is used as a quantity representative of the driver's braking request.

40. The method as claimed in claim 21,
the method further comprising that the pressure of the independent pressure source is generated by actuation of a motor of a motor-pump unit and is stored in a hydraulic high-pressure accumulator,
wherein a point of maximum boosting of the hydraulic booster is determined on the basis of a ratio between the pressure in the hydraulic accumulator and the pressure in the master brake cylinder and a constructive ratio between the surface of a hydraulic piston in the hydraulic booster and the surface of a hydraulic piston in the master brake cylinder.

41. The method as claimed in claim 21,
the method further comprising that the pressure of the independent pressure source is generated by actuation of a motor of a motor-pump unit and is stored in a hydraulic high-pressure accumulator,
wherein the braking pressure in the wheel brakes is controlled by way of switching two electronically actuatable valves in a closed hydraulic system.
